(19) United States
(12) Patent Application Publication
(10) Pub. No.: US 2006/0109750 A1
(43) Pub. Date: May 25, 2006

(54) Electronic reminder device and related method

(76) Inventors: Michael Scott McCracken, Nashville, TN (US); Shirley Jean Byler McCracken, Nashville, TN (US); David Martin McCracken, Nashville, TN (US)

Correspondence Address: W. EDWARD RAMAGE, COMMERCE CENTER SUITE 1000, 211 COMMERCE ST, NASHVILLE, TN, 37201, US

(21) Appl. No.: 11/271,178

(22) Filed: Nov. 11, 2005

Related U.S. Application Data
(60) Provisional application No. 60/626,740, filed on Nov. 11, 2004.

(51) Int. Cl. G04B 23/02; G08B 1/00

(52) U.S. Cl. 368/244; 340/309.16

(57) ABSTRACT

An electronic reminder, the alert feature of which uses visual and/or audible alert signals, with customizable surface areas. The surface areas include an area onto which a distributor of the reminder can apply information specific to a known end user or user group. A surface area of the housing also permits a purchaser of relatively small quantities of the invention to apply their own promotional information prior to redistribution to their customers. Another area of the housing includes a surface area of such material as to allow the end user to handwrite information associated with the reminding function, such as the storage location and brand name (or product type) of a particular item, or a task. A display device permits a user-defined, reminder-related visual cue (for example, a photograph) to be held in place and displayed. Additionally, the reminder may include a heart-shaped lens that illuminates when the alert occurs, flashing (and/or sounding) in the familiar rhythm of a human heartbeat to call attention to information about which the user is being reminded.

This application claims priority to Provisional Patent Application No. 60/626,740, filed Nov. 11, 2004, by David McCracken, and is entitled in whole or in part to that filing date for priority. The specification Provisional Patent Application No. 60/626,740 is incorporated herein in its entirety by reference.

### FIELD OF INVENTION

This invention relates generally to an electronic reminder device. More particularly it relates to an electronic reminder device with customizable surface areas for end-user specific information, or for distributors to direct specific information to end users or user groups, permitting user-defined information, photographs, or similar material to be displayed and recorded to enhance the reminding function.

### BACKGROUND OF THE INVENTION

The use of standard electronic timers and reminder devices for assisting consumers to remember to do various tasks, such as to attend a meeting, make a telephone call, or take medication, is well known. The configuration of such reminders varies widely depending on the particular application. Examples range in complexity from simple egg or oven timers used in food preparation to date-book alerting applications in cellular telephones. General purpose electronic reminders and timers also are known which permit the consumer to apply the device to whatever reminding purpose they determine to be within its capabilities.

An example of the use of such devices in the current art is in the veterinary pharmaceutical industry. Veterinary medications are often prescribed to be administered on a once-per-month basis. When a busy pet owner forgets to give a dose on time, their pet's health can be jeopardized. Furthermore, when forgetfulness causes an infrequent task like administering monthly heartworm medication to be postponed or altogether forgotten, the manufacturer or distributor of the medication suffers a delay until the consumer returns to purchase the next prescription. In the analysis of a given accounting period, this delayed revenue clearly represents lost revenue to the veterinary pharmaceutical manufacturer or distributor.

Pet owner forgetfulness is a problem that so affects pet health and so negatively impacts the revenues of the veterinary pharmaceutical industry, that companies within the industry have made substantial investments to overcome it. For example, some companies offer monthly e-mail alerts or telephone calls to remind their customers to give each monthly dose on time. Likewise, some veterinary clinics will mail postcards to their customers as a reminder. Such remedies, however, are limited in that the pet owner may not be at home or near the medication when they receive the communication, leaving them subject again to the risk that the pet owner will forget to follow through with the task.

A number of electronic reminders are available for companies to provide to their pet owning customers to remind them to administer monthly pet medicine on time. However, the unique nature of such an infrequent task calls for features not served by currently-known electronic reminders. Current devices do not allow the end user to record undivided from the reminder information about the task that may be forgotten in the intervening month since the last dose. In addition, there is a risk that a note may be lost before the next alerting cycle, a risk that increases as the length of time between reminding intervals increases. All known reminders have a housing surface that is made of various types of plastic. These surfaces do not provide an area for writing helpful information related to the reminding function, and their housing material has such high smoothness and resiliency against markings that it is an unsuitable medium for pen or pencil notations. To the extent the consumer can recall they are reminded to administer pet medicine, the product provides no specific information about what brand (or type) of medicine the user is reminded to administer, or where it is stored. Therefore, a busy pet owner may be reminded about their pet generally, without knowing precisely what it is they are to do or where they are to get the product they need to do it with. Current devices also do not help the end user who owns more than one pet to be able to distinguish one reminder from another so that doses are not improperly administered. Moreover, such devices do not permit easy and cost-effective branding by small-quantity distributors of such reminders, such as a veterinary clinic.

Furthermore, consumers using an electronic reminder over many months may grow bored of it and either stop using it or discard it altogether, due to a lack of an interesting consumer-oriented purpose to entice the user to enjoy the reminder for longer periods of time for reasons beyond the basic reminding function Thus, what is needed is an electronic reminder with customizable surface areas for use by the end-user, and for use by distributors to direct specific information to end users or user groups, and permitting user-defined information to be displayed and recorded to enhance the reminding function and encourage prolonged use of the device.

### SUMMARY OF THE INVENTION

This invention is directed to an electronic reminder device, the alert feature of which uses visual and/or audible alert signals, with a surface suitable for tailoring information to the alerting function both by the product distributor and by the end user. The device includes a means of holding or fixing the reminder device at a convenient location, such as a magnet for attaching it to a metallic appliance, such as a refrigerator. Alternatively, the device could be placed on a wire stand, or in certain configurations, could be freestanding. The present invention is particularly described in connection with application as an electronic reminder for distribution to pet owners for helping them remember to administer monthly pet medicines on time, but it may, of course, be used in any application where an electronic reminder is used.

The electronic reminder device comprises a housing, power source, timer circuitry, visual and/or audible signals to alert the user at the appointed time, and an input (or inputs) to permit the user to program or otherwise activate and acknowledge the alerting function. While the timing of the alerts can vary, in one exemplary embodiment, the device provides alerts on a monthly basis.

In one exemplary form, one or more surfaces, including but not limited to the front or top surfaces, of the housing provide one or more writing areas conducive to handwriting information related to the reminding function. The writing area may comprise material comparable to the signature strip found on the back of consumer credit cards, whereupon the user signs her name for identity authentication. Alternatively, the writing area can comprise material where the written information can be erased and the writing area reused.

With prompting from the simple instructions under a blank space of proper length and surface quality, a customer can then write, for example, “heartworm medicine” above a “medicine type” line and “kitchen desk drawer” above a “location” line. This feature permits, for example, a veterinary pharmaceutical manufacturer or distributor to avoid the expense of purchasing and warehousing a reminder branded for each medicine their customers purchase. Furthermore, this feature makes the disclosed invention flexible and user customizable to their particular product type and storage preferences, enhancing the electronic reminder's ability to assist the consumer with complete information at the time the task is to be done.

In another exemplary embodiment, the housing may be designed to hold in place and display a user-defined/selected, reminder-related visual cue. For example, a transparent Lexan or Plexiglass sleeve, affixed to the front surface of the reminder, permits the user to insert a photograph of the pet to which the reminder applies. Alternatively, a series of slots or grooves may be used, or a display compartment. In one embodiment, the display feature may comprise three raised grooves along three sides of a rectangle, where a photograph or picture may be inserted through the open fourth side. In the case of homes with multiple pets, the display feature consequently makes it easy for the owner to know which reminder is for which pet. Additionally, this feature makes the present invention double as a picture frame and therefore presents itself as a more interesting and aesthetically acceptable device to consumers, making the reminder more likely to be used and for a longer period of time. In another exemplary embodiment, the display means could also be adapted to contain written material or notes from the consumer, the distributor, or both.

The alerting cycle provides a further opportunity to increase customer acceptance of electronic reminders. Known electronic reminders use a light emitting diode (LED) or other display device and use a sounding means, such as a piezo buzzer; these serve the reminding purpose but do not enhance it by highlighting the pet owner's affection for their pet. In yet another exemplary form, the present device provides a novel alerting feature by alerting the user with a flashing heart-shaped or Valentine-shaped lens that flashes in the familiar rhythm of a human heartbeat, and, if equipped with a sound generating means, by sounding in a like manner. Unifying the heart shape with the flashing/alerting function creates a marketing advantage to those companies who sell or provide the disclosed invention with the pet medicines their customers buy, primarily for three reasons. First, many pet medicines are heart related, so the reminding function is reinforced more than with a typical electronic reminder. Second, most pet medicines are purchased by pet owners who love their pets, so the heart theme plays to that affection and tends to turn a chore into a labor of love. Third, the enhancement of such feelings of affection is a service that pet owners are likely to recognize and reward with brand loyalty to the veterinary medicine suppliers who provide it.

In yet another embodiment, use of the present invention is enhanced by the efficiencies of modern database technology. Companies are now able to identify, analyze and track a variety of demographic and geographic information about their individual customers and deliver targeted information, products and services back to their customers to reinforce post-purchase behavior and brand loyalty. For example, a pharmacist can provide not only a patient her medicine, but also a printed message targeted to that particular consumer warning her to guard against possible drug interactions based on therapies or conditions in her own medical history. Thus, another exemplary form of the present invention provides a surface area onto which a distributor of the reminder can apply a self-adhesive pre-printed label with specific database information targeted to a certain end user or user group. For example, a pet medicine distributor may wish to provide their customer the convenience of having his pet's name and veterinary clinic name and contact information on the reminder. Or, a pet medicine distributor may wish to promote a veterinary partner local to their customer, but different from the prescribing veterinarian, by offering on the reminder the name and contact information of a specific veterinary clinic with which it has partnered in a certain geographic region. Having the label-ready surface area would permit this kind of database intensive targeting without the high costs of custom printing onto small quantities of electronic reminders. This feature makes the electronic reminder customizable for the benefit of distributors and users of the invention.

In a further exemplary form, the present invention provides a surface area on the housing onto which a purchaser of relatively small quantities of the invention can apply their own promotional information, prior to redistribution to their customers. By applying a pre-printed, self-adhesive label to a designated surface area, just like the companies that have greater economies of scale, a smaller company is then able to brand the product with their own logo indicia and achieve better brand loyalty among their customer base. These smaller companies thus are able to avoid the costs of custom printing, which often would be cost prohibitive.

In another exemplary form, the present invention requires only one step to begin the reminder's countdown to the next month's dose of medicine. This step is to remove the battery isolator pull-tab that separates the battery(ies) from the timer circuitry. Once removed, the timer is put in circuit and immediately begins counting down. This both preserves battery life, avoiding batteries discharging in shipment (especially when shipment is delayed), and makes the apparatus very easy to use, avoiding the fairly complicated programming that is often required by reminder devices in the present art to activate the timer circuitry. Accordingly, the device is more likely to have its intended reminding effect.

In yet another exemplary embodiment, the timing mechanism that is put into effect depends upon a particular operative sequence for the reset button. Thus, for example, the timer may default to a monthly reminder cycle. Pressing and holding the reset button for a short period of time, such as four seconds, would cause the timer to give alerts on a weekly cycle. Pressing and holding the reset button for a longer period of time, such as eight seconds, would cause the timer to give alerts on a daily basis. Similar timing cycles could be selected by other means, such as pressing the button for a certain number of times in sequence.

Still other advantages of various embodiments will become apparent to those skilled in this art from the following description wherein there are shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### DESCRIPTION OF THE DRAWINGS

FIG. 1a is a front elevational view of one embodiment of the present invention.

FIG. 1b is a front elevational view of another embodiment of the present invention.

FIG. 2 is a profile view of the invention of FIG. 1

FIG. 3 is a rear cutaway sectional view of the invention of FIG. 1.

FIG. 4 is a simplified block diagram illustrating principal functional components of the present invention.

FIG. 5 is a perspective view of one embodiment of the present invention.

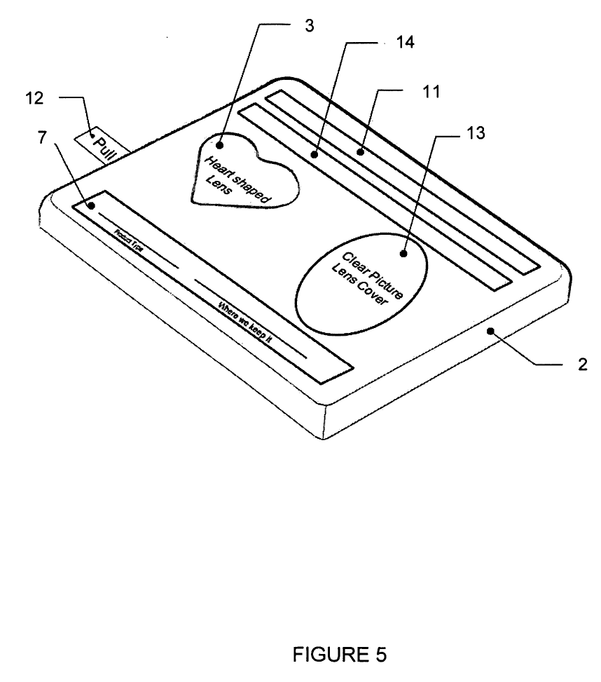

FIG. 6 is a front elevational view of another embodiment of the present invention.

FIG. 7 is a front perspective view of the invention of FIG. 6.

FIG. 8 is a rear perspective view of the invention of FIG. 6.

FIG. 9 is an exploded front view of the invention of FIG. 6.

FIG. 10 is an exploded rear view of the invention of FIG. 6.

### DETAILED DESCRIPTION OF THE INVENTION

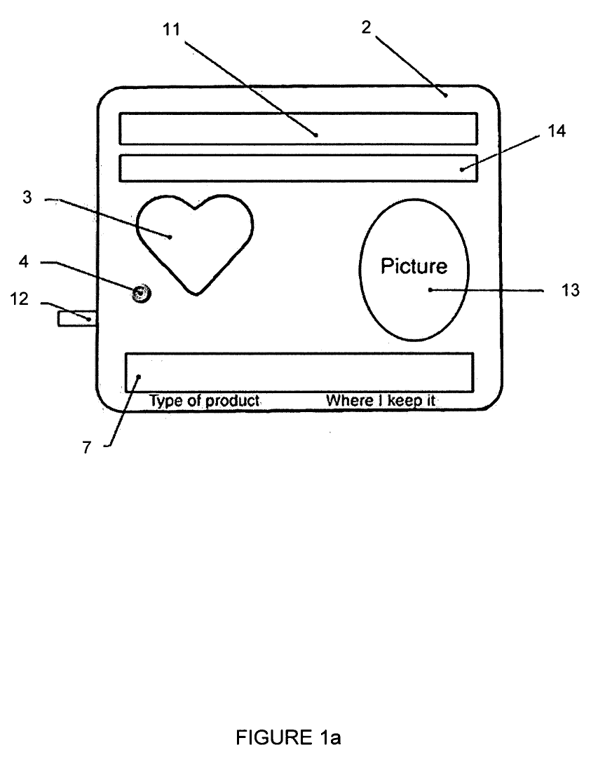

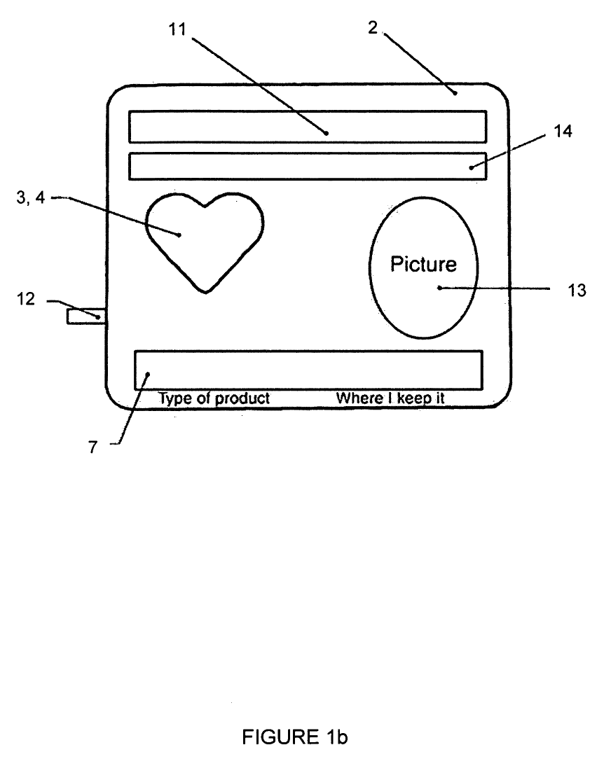

Referring now to the numerous figures, wherein like references identify like elements of the invention, FIG. 1 illustrates an exemplary embodiment of the invention comprising a housing 2 containing timer circuitry (not shown) and means for alerting, such as a sound device (not shown) and/or an LED (not shown) behind or illuminating a lens 3 or other transparent or translucent material that functions as a visible alerting means. While FIG. 1 shows the lens 3 in the shape of a heart, the lens 3 can be any shape.

In one exemplary configuration, the timing mechanism is initiated by removal of a battery isolator pull-tab 12. When the alert function is triggered, the alert can be acknowledged and reset by means of a reset button 4. The reset button 4 can be a separate, standalone button placed in a convenient location on the housing, as shown in FIG. 1, or the lens 3 may function as a reset button, as shown in FIG. 1a. Pressing the reset button 4 or lens 3 serving as a reset button causes the alarm function to reset itself. Alternative configurations may be selected based on manufacturing cost and customer preferences. The reset button 4 also may function as a test button to enable periodic testing of various alert functions.

One or more surfaces, including but not limited to the front or top surfaces, of the housing may comprise a handwriting surface area 7 for handwritten notations by the consumer or end-user, a sellers or distributors custom branding or labeling area 11 (although a logo, brand, or label can be placed elsewhere on the housing 2), and a database information surface area 14. In another exemplary embodiment, a display sleeve 13 provides a place for pictures or any user-defined visual cues.

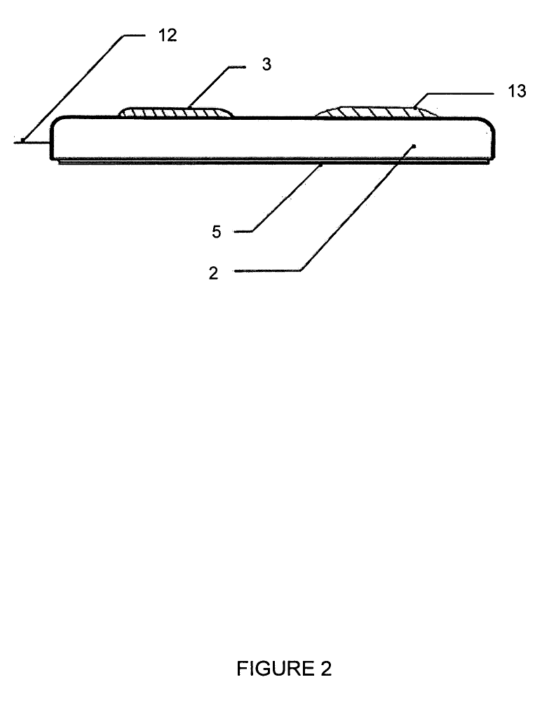

FIG. 2, which illustrates a profile view of the electronic reminder device of FIG. 1, shows the housing 2, the top of the lens 3, which also may function as a dual lens/reset button, and the display sleeve 13. In yet another embodiment, the lens 3 and the display sleeve 13, may be flush with the housing 2, or inset.

Embodiments of the invention may comprises a means of holding or fixing the reminder device at a convenient location, such as a magnet 5 for attaching it to a metallic appliance, such as a refrigerator. Alternatively, the device could be placed on a wire stand, or in certain configurations, could be freestanding. As seen in FIG. 2, a magnet 5 is seen protruding slightly from the back of the housing 2. The battery isolator pull-tab 12 also is seen protruding from the side of the housing 2.

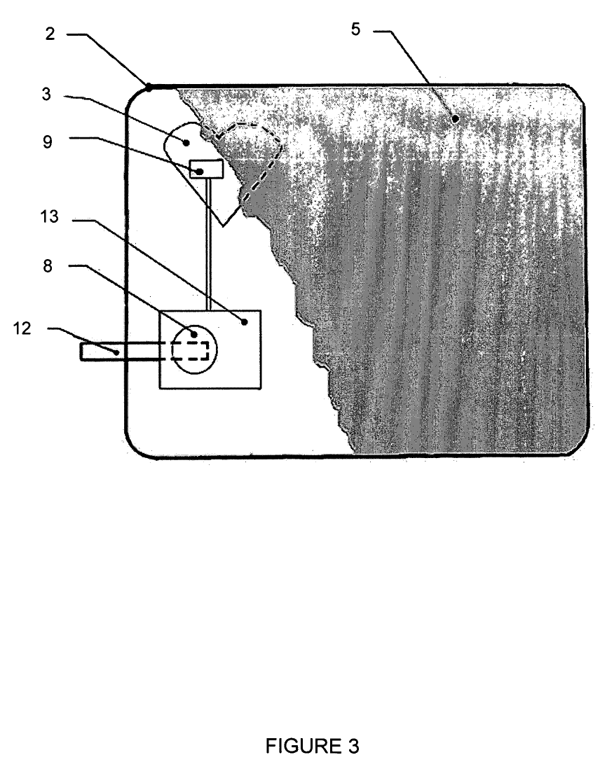

FIG. 3 shows the housing 2 and the magnet 5 with a rear sectional cut-away view showing the electronic timer circuitry and battery and the circuit board 15 as unifying all functional timer and alert components (i.e., 4, 6, 6a, 8, 9, 10, and 12) within the housing 2. The magnet 5 can be a common thin rubberized type magnet of the type commonly used for removable magnetic signage used on cars and trucks, a metallic round “button” magnet, or any other shape of magnet strong enough to hold the device. In a preferred embodiment, the magnet 5 is sufficiently strong to hold the device and several sheets of paper, giving the current invention the added usefulness of what people consider a regular “refrigerator magnet” to do (i.e., hold up pictures, grocery lists, receipts, notes and the like). The battery isolator pull tab 12 protrudes out of a slot in the housing 2. The pull tab 12 initially isolates the battery 8 from the timer circuit board 15. When the pull tab 12 is removed, the battery 8 provides power to the timer circuit board 15, electrically connected to illumination or visual alerting means 9, such as a light bulb or LED, under the lens 3.

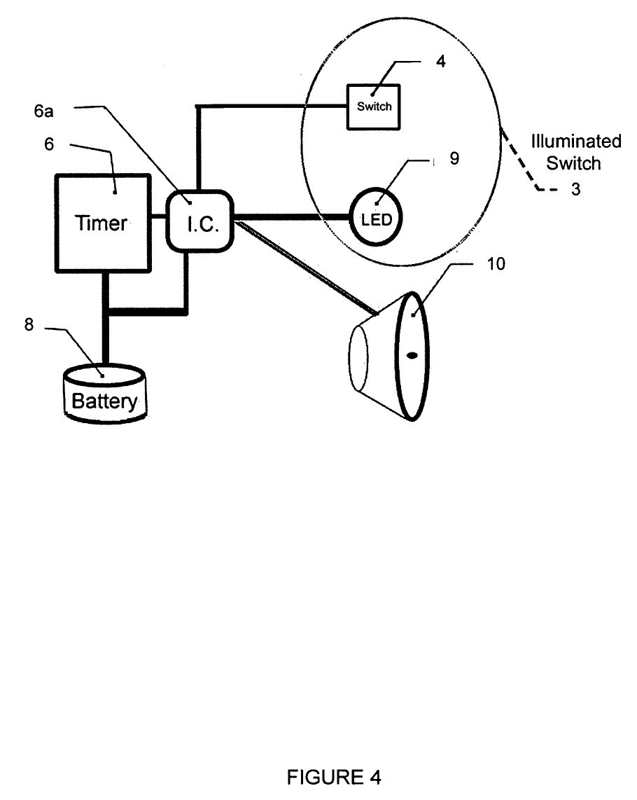

FIG. 4 shows the principal function components of one exemplary embodiment of the present invention. The timing circuitry, comprising a timer 6 and integrated circuit 6a, is powered by a battery 8, and by means of the integrated circuit and timer is adapted to provide an activation signal to a light source or LED 9 and/or sound generating means 10 after a set time interval. A reset switch 4 is electrically connected to the integrated circuit. The lens 3 covers and is illuminated by the light source or LED 9. In one exemplary embodiment, as shown in FIG. 4, the reset switch 4 is incorporated with the lens 3 so as to form one functional component.

The housing 2 may be formed of a plastic of various shapes and colors and of a size to contain the circuitry 15 and elements required of the apparatus to function as a timer. In one exemplary embodiment, the housing is boxlike, with a square or rectangular top. Alternative embodiments may be formed according to themes appropriate to particular industries or purposes for which they will be distributed. Thus, the housing may be in the form of a dog, cat, other animal, a dog or cat paw, or a heart. Similarly, the components can be varied in size and shape and location on the housing. In another exemplary embodiment, for example, the housing 2 could be in the shape of a picture frame with an or all of the components 3, 7, 11, 12, 14, mounted or framed around a larger display sleeve or picture area 13 such as would display a photograph or picture of varying size, including but not limited to a conventional 4″×6″ photograph.

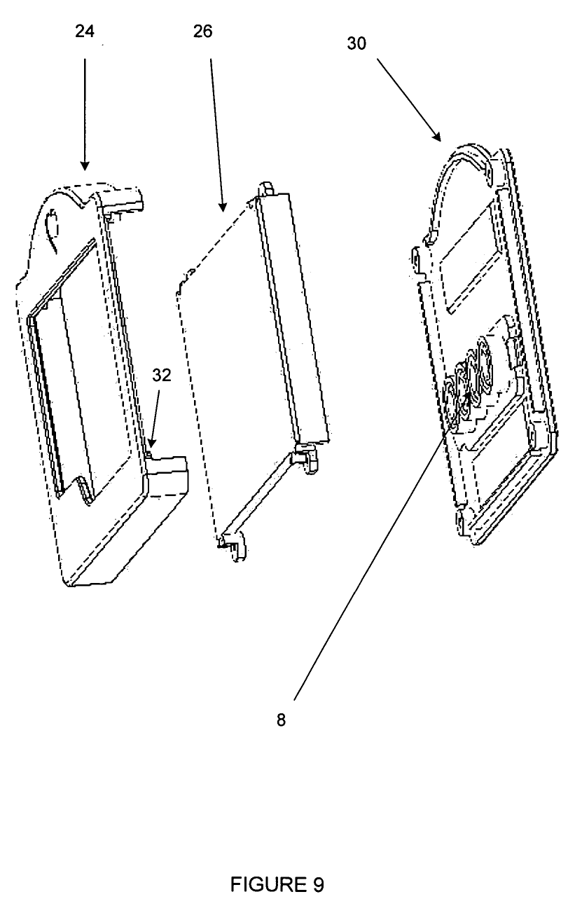

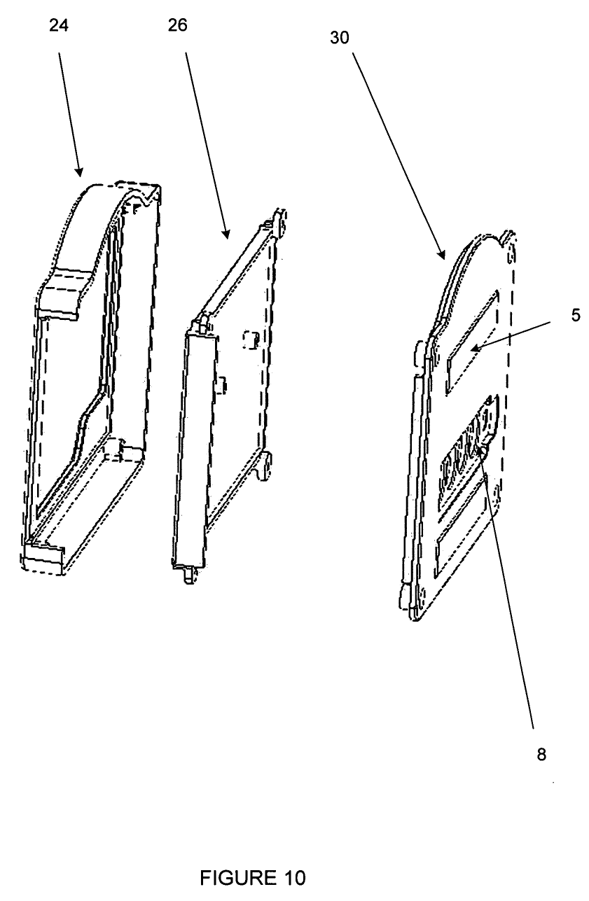

Many interval timers include means which count down a specified amount of time including either a visual or sound alarm energized when the specified amount of time has elapsed. The electronic timing circuit 6 and 6a used in this invention to independently count down a timing interval is readily available, well known to a person skilled in the art, and the specifics of how a timer functions are not discussed further herein. The timer circuitry 6 and 6a would have batteries 8 such as a button cell or other type operably connected to said timer circuitry 6 and 6a. Batteries of suitable strength are required to facilitate full functionality for the duration necessary. One embodiment would be a device that is designed to be disposable and therefore would not have replaceable batteries. In another exemplary embodiment, the housing 2 has a battery plate or panel 40 on the back that would facilitate the replacing of the batteries, as seen in FIGS. 9 and 10. In one exemplary embodiment, the timer would be designed to give an alert every twenty eight (28) to thirty (30) days over a twelve (12) month period, and, therefore, may require several “button” style batteries to last that period of time. However, any combination of batteries could be used to facilitate power needs in view of various timer duration requirements.

A battery isolator pull tab 12 aids in extending timer shelf life. Pulling that tab 12 out is the first and only activation required to start the countdown to an alert sequence. The reset/test switch button 4 operably connected to the timer circuitry 6, 6a will restart or test the timer. In one exemplary embodiment, if the button 4 is pressed briefly it will activate the light source 9 and/or sound generating means 10 as a test, which will result in several timed flashes and/or beeps indicative of a functional system. If said button 4 is pressed and held for more than five (5) seconds or some other pre-established duration it will reset the timer and start a new count. It also will result in a number of timed flashes and/or beeps indicative of a functional system that has been reset.

In another exemplary embodiment, a novel surface area to be written or inscribed on (a “write-in label”) 7 is provided. The user can use this surface area to enter information about the particular use, product or activity for which the present invention is designed to alert and remind. The writing area 7 can be comprised of material such as the signature line on the back of a credit card, or the like. Alternatively, the writing area 7 may comprise an erasable surface. The writing area 7 is affixed to the housing 2 in an appropriate space, although the exact location on the housing 2 may vary. This area 7 will allow the user of the reminder device to write in, for example, the product or activity that user desires to use or do and in the case of a product, where that product is stored (e.g., “pets heart medication” and “kitchen drawer”). Another nonexclusive example would be “change house filter” and “down stairs closet”. This feature is particularly beneficial because it enables the invention to be used for a multitude of medications, products, and uses, and thus the seller of a product does not have to stock a reminder device for each product it sells. A single configuration of a reminder timer can thus be used for all such products.

As shown in FIG. 1, one embodiment of the present invention includes an area or areas 11 where a seller can display a logo, insignia, trademark, service mark, or a similar image or statement to “personalize” or “customize” the product to advertise and promote the seller's company or product (e.g., “ACME Veterinary Clinic”). The logo or insignia can be printed or affixed to the housing 2 in a variety of ways, including but not limited to direct printing, silk-screening, a stamp, or a stick-on label. The size and location of the logo area 11 depends on the size and shape of the housing 2, and may, for example, be located on a side or top surface, or elsewhere. In a preferred embodiment, the logo area 11 is of sufficient size to allow the addition of trademark indicia such as “Your heart is why you remember™”.

One advantage of using a stamp or similar labels is to facilitate the ability of a wholesaler or distributor to sell an exemplary embodiment of the invention to several businesses without the need to tailor each lot of the present invention to multiple sellers. This production method lowers costs to those sellers and ultimately, lowers costs to the consumer or final end user. The sellers are able to then “customize” the present invention to their own needs. An example of such a seller would be a veterinary clinic that might not purchase enough bulk lot of units at one time to justify the cost of manufacturer added labels. This feature could also facilitate “customizing” a label for each device to show that seller's (e.g., a veterinary clinic's) name and phone number for easy user recall. As a further nonexclusive example, such labels can be customized by a veterinary clinic to include the name of the particular pet that reminder is to used for (e.g., “Fido's next rabies shot is due 12/15 at 2:15 pm”).

In another embodiment, a surface of the reminder has an area where a picture or visual cue can be displayed. The picture or visual cue can be attached or affixed through a variety of attaching means, including but not limited to a transparent or clear plastic shell, frame, or lens that clips, sticks, glues, or is otherwise affixed onto the housing 2. In one exemplary embodiment, a plastic shell, frame, or lens is clipped to the housing through the use of integrated plastic tabs with shell, or small tabs cut or molded into the housing 2, that the corners of a picture could be folded into, or affixed to, with or without the use of a transparent lens or covering. As a nonexclusive example, an end user may attach a picture of their pet to the device so that the user can know which pet is to have medication administered. This would also allow the user to enjoy seeing a picture of their pet during the time between alerts (which can be of long or short duration) and thus give the current invention more usefulness to that user.

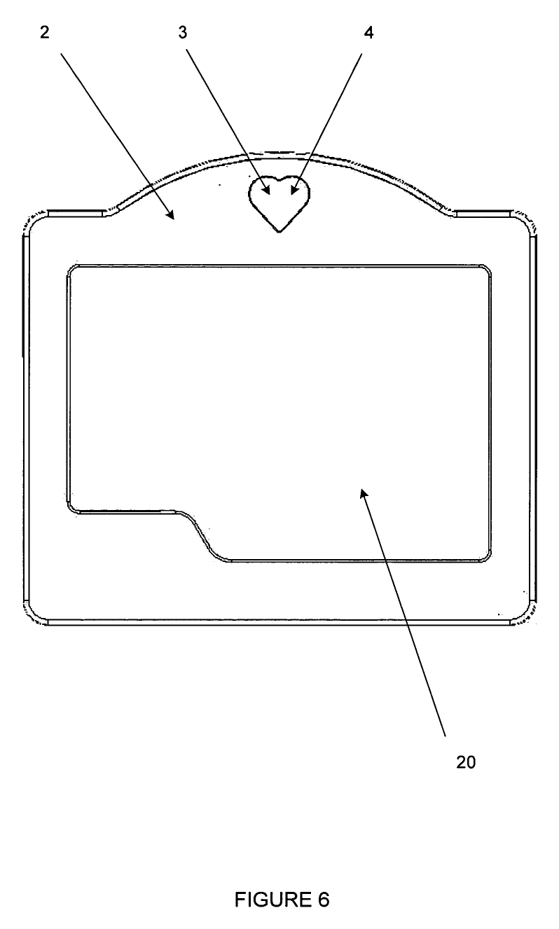

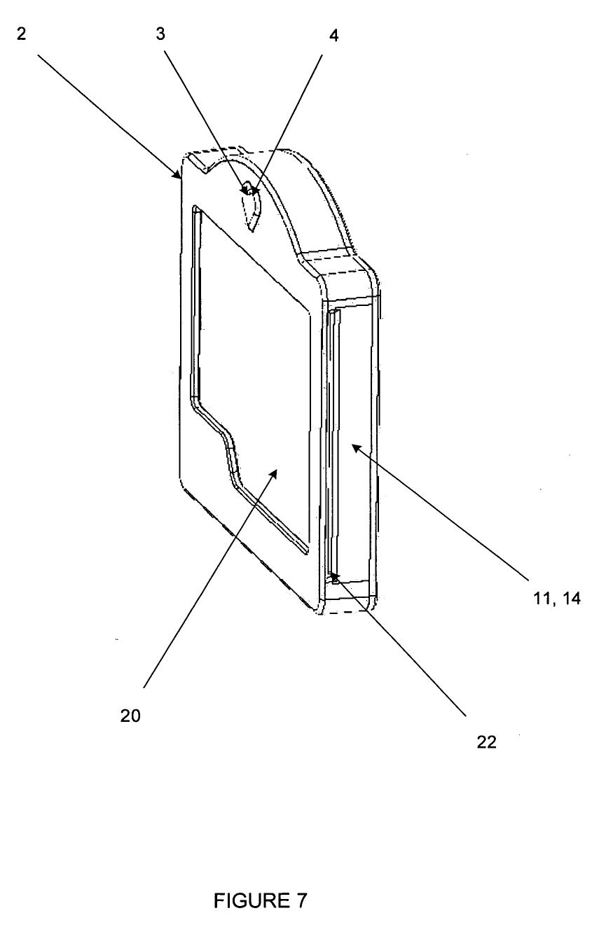

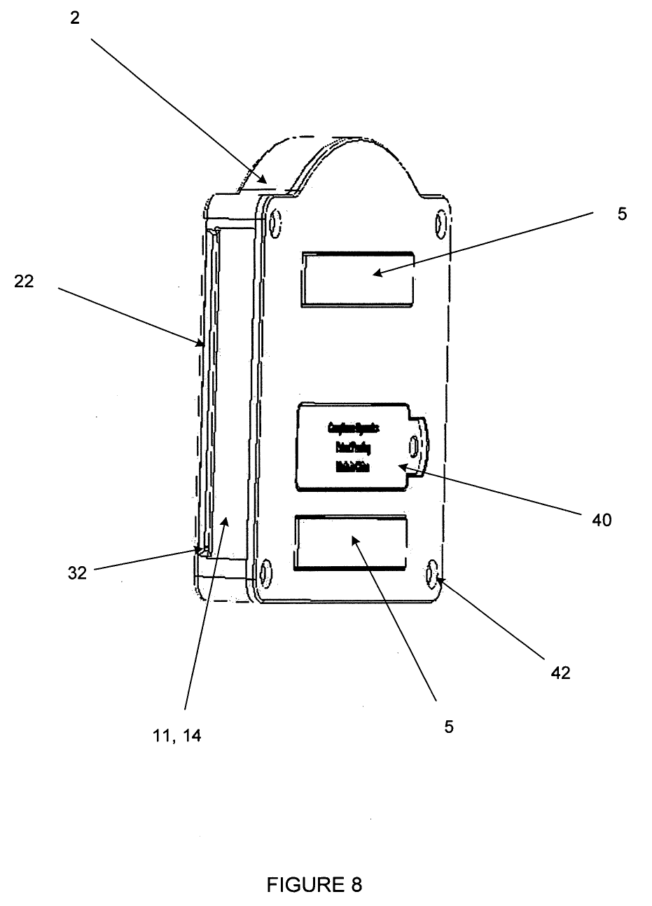

FIGS. 6 through 10 show another exemplary embodiment of the present invention with display means comprising an display compartment 20 that covers a substantial portion of the front of the housing 2. In this or similar alternative configurations, the invention can function as a picture frame with a timing mechanism. A picture or visual cue is inserted through a slot 22 on one side. FIG. 7 shows one possible configuration with the slot 22 on the right side of the housing 2 when viewed from the front. A battery plate 40 provides access to one or more batteries 8, and is shown located between two magnets 5 in this embodiment. Various faces of the housing may be used for writing surfaces, database information areas, logo indicia areas, or the like.

In this exemplary embodiment, the display compartment 20 can be formed as an integral part of the housing 2, or may be formed by components of the housing, as seen in FIGS. 9 and 10. A inner display plate 26 fits on the housing base 30. A front perimeter frame 24 is placed over the inner display plate 26 to retain the photo, picture, card, or other visual cue. The front perimeter frame 24 prevents the material being held from falling out of the display compartment 20, established by the gap between the front perimeter frame 24 and inner display plate 26. The material is inserted through a slot 22 formed on one side. These components may be snap fit, or fastened together by clips, glue, adhesive, rivets, screws, or a similar fastener 42. This embodiment also may reduce the expense and difficulty of manufacturing a unitary die-cast timer housing using current injection-mold technology, as it avoids high rejection rates and other problems associated with using void-creating mold blanks.

In another alternative embodiment, a small ridge, lip or protrusion 32 may be used to inhibit the material being held from sliding out of the display compartment 20 through the slot 22. The protrusion 32 may be positioned at one or both ends of the slot 22, or may extend for a portion or the entire length of the slot 22.

In yet another embodiment of the invention, the alert function is enhanced by using the beat or rhythm of a heartbeat. This would be accomplished by the programming of the integrated timing circuitry 6a. The timer circuitry 6a may be preprogrammed for a timing cycle that is appropriate for the activity associated with the timer. When the present invention operates in alert mode, it may flash or illuminate the lens 3 via light source means 9. The flashing of the lens 3 may be intermittent, using the normal rhythm of a heartbeat. The device also may provide an aural alert through sound generating means 10, which similarly may pulse intermittently in the frequency of a human or mammal's heartbeat. As a nonexclusive sample, a general timing sequence could be a 100 or 200 ms alert, then a 1000 or 1500 ms pause, followed by a 100 or 200 ms alert, followed by a 1000 or 2000 ms pause, and repeat. As a further nonexclusive sample, a general timing sequence could be a 250 or 350 ms alert, then a 1500 or 2500 ms pause, followed by a 250 or 350 ms alert, followed by a 6000 or 7000 ms pause, and repeat. In one embodiment, the pattern would generally follow the pattern of a human heartbeat. An alert function using this timing is more likely to be noticed by the user, and is likely to be less annoying that the well known constant “BEEP, BEEP, BEEP” of most timer alerts. The heartbeat timing of the alert function also corresponds with the trademarked phrase “Your Heart is why you remember™” and other similar trademarks that invoke a heart-related theme, especially when used in combination with a heart-shaped lens 3 and/or picture area 13 which evokes the user's affection for their pet.

In an exemplary embodiment, when the timer is used for the first time all the user needs to do to start the timing sequence is pull the battery isolator tab 12 out. This operably engages the battery with the timer circuitry and will start the timing process. In one alternative, for example, the timer may default to a one month timing upon removal of the tab 12. Nothing else is required of the end user until the unit provides an alert. The timing circuitry also may send functionality alerts (visual and/or audible), 3, 9, 10, to notify the user that the unit is working.

As a nonexclusive example, when used for veterinary heart medication, the unit would give an alert approximately 28 days after the tab 12 is pulled. To conserve battery life, the unit may only provide a limited alert initially. Thus, for example, during days 28 and 29 (or some other suitable time period), the alert may be purely visual, e.g., the flashing light with heartbeat pattern. If the user has not pushed the reset button or switch 4 in that time period, the unit would continue to provide an alert with the same visual pattern as for the prior period, but also add an audible tone or beep through the sounding means 10. As described above, this could be a tone with the timing and sound of a heartbeat. The timing cycle for this audible signal may vary. For example, the tone or beep may sound every 10 to 15 minutes until the unit is reset. The timing of this audible alert may be shortened with increased passage of time without a reset. If the unit is not reset after a period of time, such as, for example, 5 days, the device may go to a battery save mode and shut off the alarms in whole or in part. An alert could then be provided again when the alert period has elapsed again (e.g., twenty-eight days), and this type of timing cycle, depending on the programming, would continue until the desired preprogrammed time has elapsed, at which time the unit would either shut down or continue this cycle until the batteries 8 run down. These timing cycles are easily programmed in a variety of different cycle times and alert timing ways through the use of the integrated timing circuit.

In another embodiment, the timing mechanism that is put into effect depends upon a particular operative sequence for the reset button. Thus, for example, the timer may default to a monthly reminder cycle. Pressing and holding the reset button for a short period of time, such as four seconds, would cause the timer to give alerts on a weekly cycle. Pressing and holding the reset button for a longer period of time, such as eight seconds, would cause the timer to give alerts on a daily basis. Similar timing cycles could be selected by other means, such as pressing the button for a certain number of times in sequence. The above timing examples are in no way intended to limit the scope or range of timing options, but only as an example of what can be programmed by those skilled in the art and one preferred use of the invention 1.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

We claim:

1. A timer, comprising:
a housing having a plurality of surfaces, including but not limited to a front surface and a back surface, the housing defining a cavity;
timing circuit means disposed within the cavity;
a lens connected to the housing;
alert means activated by the timing circuit after the passage of a period of time;
and control means coupled to said timer and operable to cause said timer to initiate a timing cycle.

2. The timer of claim 1, wherein the lens comprises the shape of a heart.

3. The timer of claim 1, wherein the alert means comprises a light source, an audible indicator, or both.

4. The timer of claim 3, wherein the light source comprises one or more light emitting diodes.

5. The timer of claim 3, wherein the light source is located behind the lens.

6. The timer of claim 3, wherein the light source flashes on and off in time with a human heart-beat.

7. The timer of claim 3, wherein the audible indicator is a series of sounds in the rhythm of a human heartbeat.

8. The timer of claim 1, wherein the control means comprises a reset button on the front surface.

9. The timer of claim 1, wherein the lens also functions as the control means.

10. The timer of claim 1, further comprising a battery isolator pull-tab.

11. The timer of claim 1, further comprising a handwriting surface area on a surface of the housing.

12. The timer of claim 1, further comprising display holding means on a surface of the housing.

13. The timer of claim 12, wherein the display holding means comprises a clear plastic sleeve.

14. The timer of claim 12, wherein the display holding means comprises a display compartment and an insertion slot, with a retaining protrusion at one end of the insertion slot.

15. The timer of claim 1, further comprising a logo indicia area on a surface of the housing.

16. The timer of claim 1, further comprising a database information surface area on a surface of the housing.

17. The timer of claim 1, further comprising mounting means.

18. The timer of claim 17, wherein the mounting means is a magnet affixed to the rear surface of the housing.

19. The timer of claim 1, wherein the particular timing cycle initiated depends on either the length of time the control means is activated or pushed, or the number of times the control means is activated or pushed in sequence.

20. A timer, comprising:
a housing having a plurality of surfaces, including but not limited to a front surface and a back surface, the housing defining a cavity;
timing circuit means disposed within the cavity;
a heart-shaped lens connected to the housing;
display means on one or more surfaces of the housing;
alert means activated by the timing circuit after the passage of a period of time;
and control means coupled to said timer and operable to cause said timer to initiate a timing cycle.
